(19) United States
(12) Patent Application Publication
(10) Pub. No.: US 2011/0227444 A1
(43) Pub. Date: Sep. 22, 2011

(54) ROTATING ELECTRICAL MACHINE VOLTAGE EQUALIZATION TOPOLOGY

(76) Inventors: Harold C. Scott, Lafayette, CO (US); Davey E. Williams, Loveland, CO (US)

(21) Appl. No.: 13/052,377

(22) Filed: Mar. 21, 2011

Related U.S. Application Data
(60) Provisional application No. 61/315,630, filed on Mar. 19, 2010.

(51) Int. Cl. H02K 3/28

(52) U.S. Cl. 310/208

(57) ABSTRACT

A winding for an electric machine having a plurality of coils wound about a lamination stack or other suitable ferro-magnetic carrier, comprising each of several phases. Each of several filars comprising said coils distributed circumferentially around the laminations in a woven manner. Each of said filars consisting of one or more continuous conductors deposed into lamination slots in such manner that each filar is equidistant from the axis of the stator.

### CROSS-REFERENCE TO RELATED APPLICATIONS

This Application claims the benefit of U.S. Provisional Application 61/315,630 filed on Mar. 19, 2010.

### BACKGROUND

An electrical machine of either motor or generator type typically has a stator consisting of generally cylindrically shaped core laminations with a plurality of slots deposed circumferentially about the stator. The stator may be deposed either radially inward or outward of the rotatable portion of the machine. The rotatable portion of the machine may in turn consist of circumferentially deposed slots. Each of these slots is typically wound with a plurality of filars comprising each of several phases. The construction of stator or rotor windings presents design challenges such as the slot segments of the windings not receiving or producing equal amounts of electromagnetic flux. This problem is caused due to different portions of a given phase coil that are at different radial positions from the flux producing or receiving part.

Previous attempts have been made to address this problem by alternating the position of each filar inwardly and outwardly along the radius of the stator and connecting the slot segments by end turns deposed in a cascaded fashion. These end turns may also be separate from the slot segments, therefore requiring welding to attach them to the slot segments. This arrangement has the undesirable effect of requiring the end turns to be increased in length to accommodate the radially inward and outward placement of the different portions of the coil, resulting in inefficiencies both electrically and in use of material. Thus, there is a need for a device that addresses the problem of varying flux density along the radius of the machine while maintaining the shortest possible end turn length.

Additionally, previous attempts have been made to address a maximization of slot fill by using rectangular slots filled with filars composed of rectangular conductors. However, this approach presents additional inefficiencies in the form of iron loss due to not maintaining a constant iron cross section in the tooth. Therefore, it would be advantageous to develop a winding method that allows constant tooth width while maintaining a high percentage of slot fill by the several filars.

### BRIEF SUMMARY

An exemplary embodiment utilizes continuous conductors to comprise each filar of a coil for any given phase. This precludes the necessity of electrically connecting separate conductors that, in prior art, comprise the end turns connecting slot segments. Each of several filars is deposed into the bottom of the supporting slots corresponding to a particular phase. Each filar is then woven into the next supporting slot corresponding to the same phase and radially on top of the next filar of the same phase. This disposition would either be radially outward, or inward, depending upon whether the coil being wound, either stator, or rotor, is encased within, or encloses, the corresponding portion of the machine. In other words, the stator may enclose the rotor, or the rotor may enclose the stator. For purposes of clarity, only one permutation, that of a stator enclosed within a rotor, will be described. In the case then of such an enclosed stator, the circumferentially placed slots will be radially outward facing. Each radial outward movement of said filar is defined to be occupying the next layer of the winding. Each filar of each phase is therefore moved radially outward to the next layer as each consecutive turn is added to that filar. In this manner each partial winding of each phase is subjected to the same amount of magnetic flux. The resulting lattice type arrangement of the end turns is therefore shorter than the cascaded end turn arrangement of prior art. Also, the use of continuous conductors precludes the need for welding or other means of attachment of the end turns to the slot segments.

An additional exemplary embodiment is disclosed, to minimize iron losses and maximize flux density, teeth maintain a constant width, which in turn results in a slot that is generally wedge-shaped. The geometry of slots and teeth drive the geometry of the arrangements of the several filars, which will be discussed in more detail below. Though in yet another exemplary embodiment a straight tooth and wedge-shaped slot configuration is described, a keystone-shaped slot and tooth geometry could offer compromise advantages; any slot and tooth geometry with other than parallel-shaped slots can take advantage of this methodology.

### BRIEF DESCRIPTION OF THE DRAWINGS

FIG. 1 illustrates an exemplary stator viewed from the end, and the slots and teeth;

FIGS. 2A, 2B and 2C illustrate an exemplary sequence and arrangement of the first three filars into, through, and (via an end turn) into the next slot in the winding sequence:

FIG. 3 illustrates an exemplary wye connection of the filars forming one coil group;

FIG. 4 illustrates an exemplary wye connection of the next coil group;

FIG. 5 illustrates an exemplary winding diagram, including all stator slots, passages of coil groups through the slots, wye connections, or neutral points;

FIG. 6A illustrates exemplary slots through which the filars of the first coil group pass;

FIG. 6B illustrates exemplary slots through which the filars of the eight coil groups pass;

FIG. 6C illustrates an exemplary winding of the first filar, and the way that the first filar is stacked upon the second filar of the same phase;

FIG. 6D illustrates an exemplary first filar of the second phase;

FIG. 6E illustrates an exemplary first filar of the third phase;

FIGS. 7A and 7B illustrate exemplary methods of the deposition of the end turns that permit a filar to leave a slot and enter the next slot in the winding sequence;

FIGS. 8A-8J illustrate an exemplary progressive fill of a slot, and in particular, the way the geometrical arrangement of the filars in the slot changes, from generally circular in the bottom of the slot, to generally planar at the top of the slot, thereby maximizing slot fill percentage; and

FIGS. 9A and 9B illustrate and exemplary forming the geometry of a filar, as it leaves a slot in a generally circular geometrical arrangement, filar is formed into a generally planar geometrical arrangement as it makes an end turn, and once again assumes a generally circular arrangement as it enters the next slot in the winding sequence.

### DETAILED DESCRIPTION

In the following exemplary embodiments, a filar is defined as one or more conducting wires, a phase is defined as a coil formed by a filar, and a coil group is defined as being made up of three phases, A, B and C. For purposes of clarity, only one example, a stator housed radially inward, (enclosed by) the rotor of a permanent magnet type alternator/motor, will be explained in detail. To one well versed in the art, the other applications will be apparent.

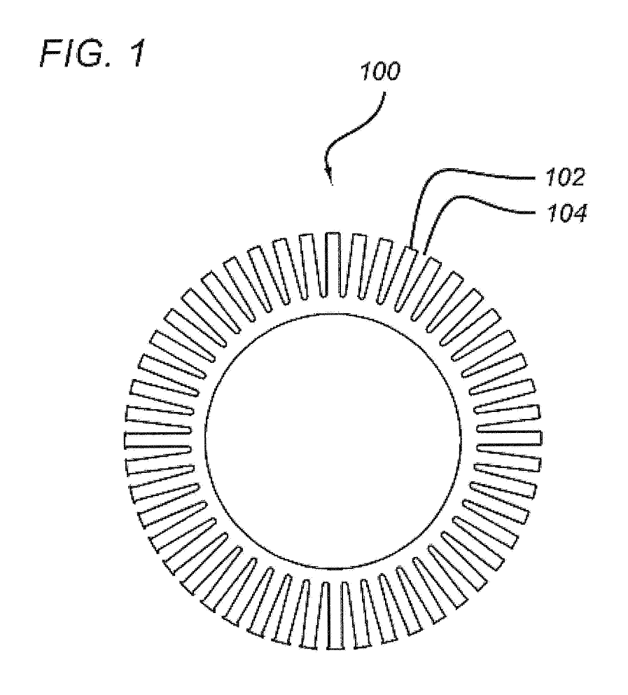

Referring to FIG. 1, a stator 100, suitable for use in a permanent magnet type machine with the stator enclosed by the rotor is illustrated. The stator includes at least one radially outward facing slot, 104, interspersed with teeth, 102, about the circumference of the stator.

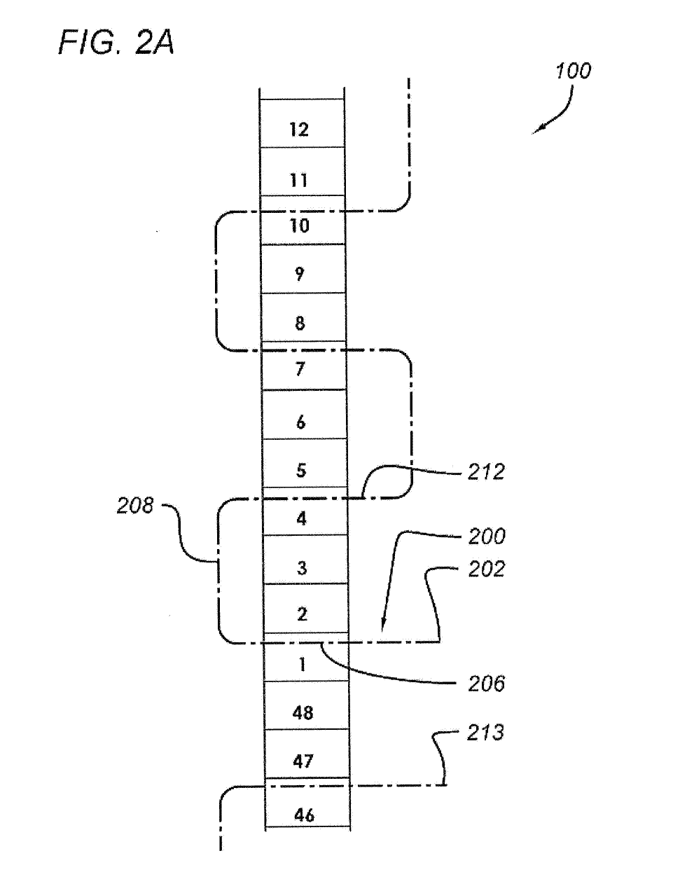

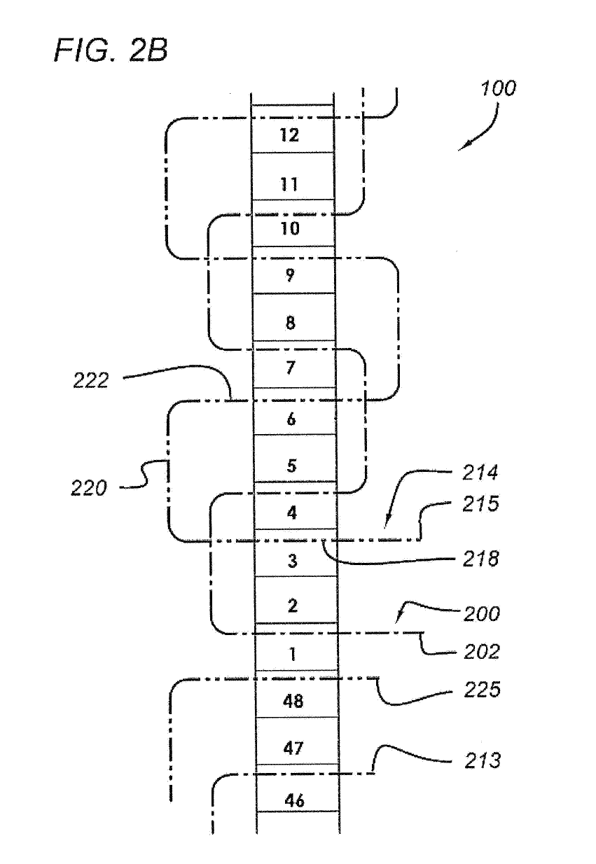

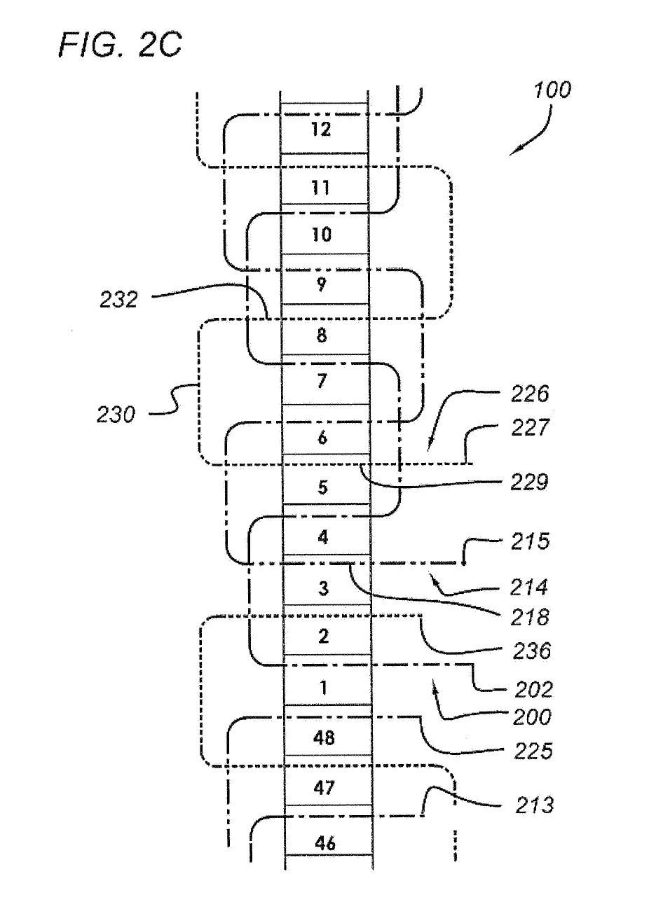

Referring to FIG. 2, an exemplary method of winding such a stator 100 is described. The view of FIG. 2 is a linear edgewise view of the circumference of the stator. FIG. 2A depicts the first of several filars being deposed about the stator. A filar 200 of a particular phase has a neutral connection 202 and a slot segment 206 is deposed into the first stator slot 1. Said filar is woven back into the stator by means of end turn 208 with second slot segment 212 being deposed into slot 4. Each instance thus described is of a filar 200 being woven onto the stator, therefore comprising one turn of the resulting coil. The number of turns required for each coil is determined by the particular voltage/current goals of a given design. The last turn of said phase coil terminates in a power output connection 213.

Referring now to FIG. 2B, a first filar 214 of a second phase is shown with neutral connection point 215 and is deposed into stator slot 3 by means of slot segment 218. This first filar of a second phase is woven into the stator by means of end turn 220 connecting to a second slot segment 222 deposed into a second slot 6. The turns of said phase coil continues in like manner as that of the first phase. Said second phase coil terminates in power output connection 225.

Referring to FIG. 2E, a first filar 226 of a third phase has a neutral connection 227 and is deposed by means of slot segment 229 into stator slot 5. This first filar of a third phase is woven into the stator by means of an end turn 230 connecting to a second slot segment 232 deposed into a second slot 8. Each iteration of said weave constitutes a turn of the third phase coil. Said third phase coil terminates in power output connection 236.

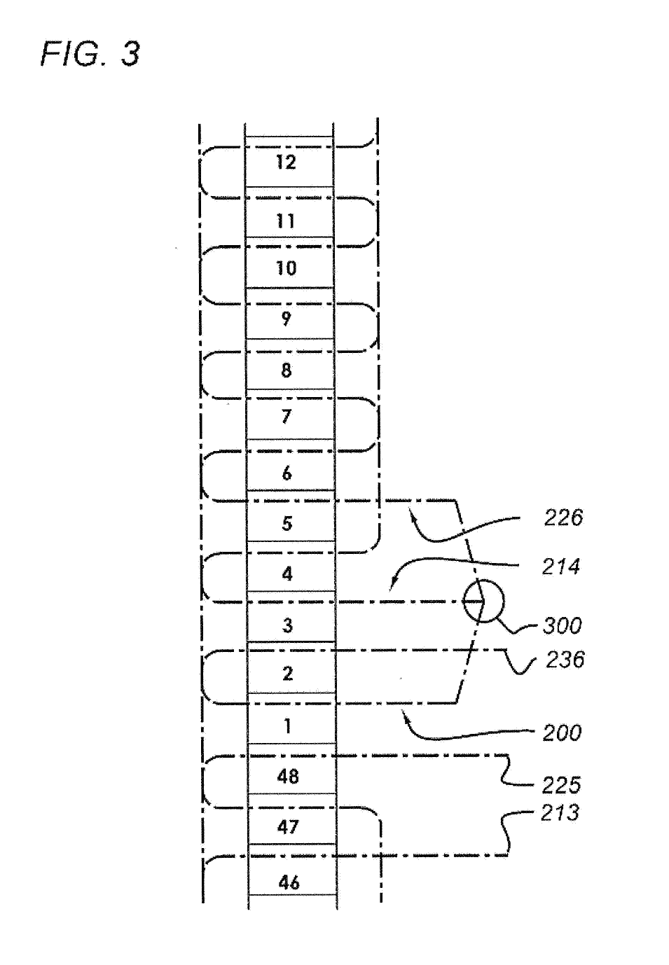

Referring now to FIG. 3, the three resulting phase coils comprised of filars 200, 214, and 226 connect in a wye configuration by means of their neutral connection points, 202, 215, and 227 at neutral connection 300. Each filar has a power output connection, 213, 225 and 236. Said three phase coils, together with their common neutral connection and separate output connections, comprise one coil group of the machine.

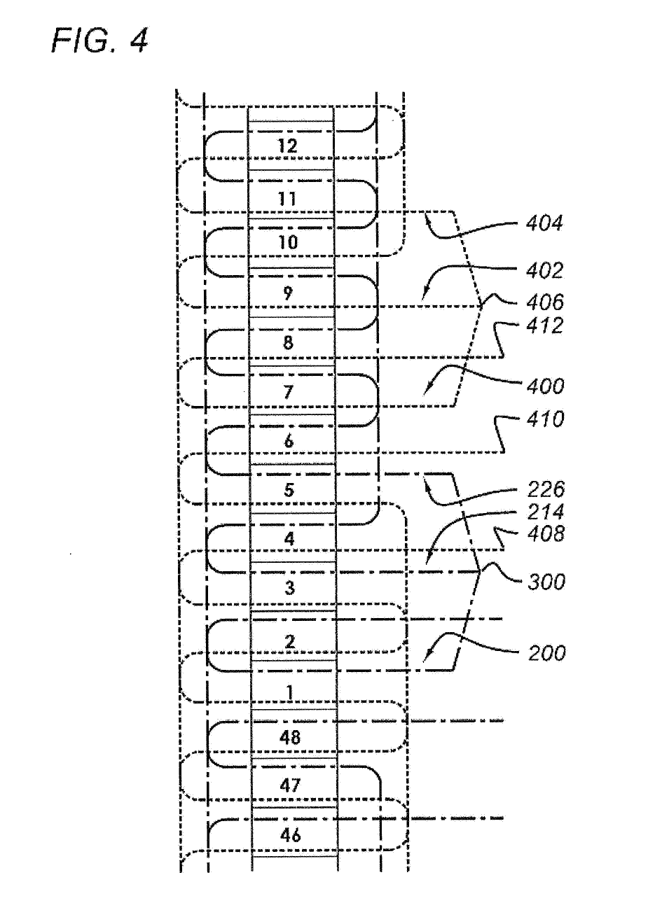

Referring to FIG. 4, in an exemplary embodiment, a second coil group is formed as follows. A filar 400 is deposed into the stator at the appropriate position slot 7 so as to be of the same phase as that of filar 200 in slot 1. Similarly, a filar 402 is deposed into the stator in such position slot 9 so as to be of the same phase as that of filar 214 in slot 3. A third filar 404 is deposed into the stator in slot 11 to be of the same phase as that of filar 226 in slot 5. These filars are woven into the stator in the same manner as were the filars of the first coil group. Similarly, the three coils thus formed will have a neutral connection at 406 and their respective power output connections, 408, 410 and 412.

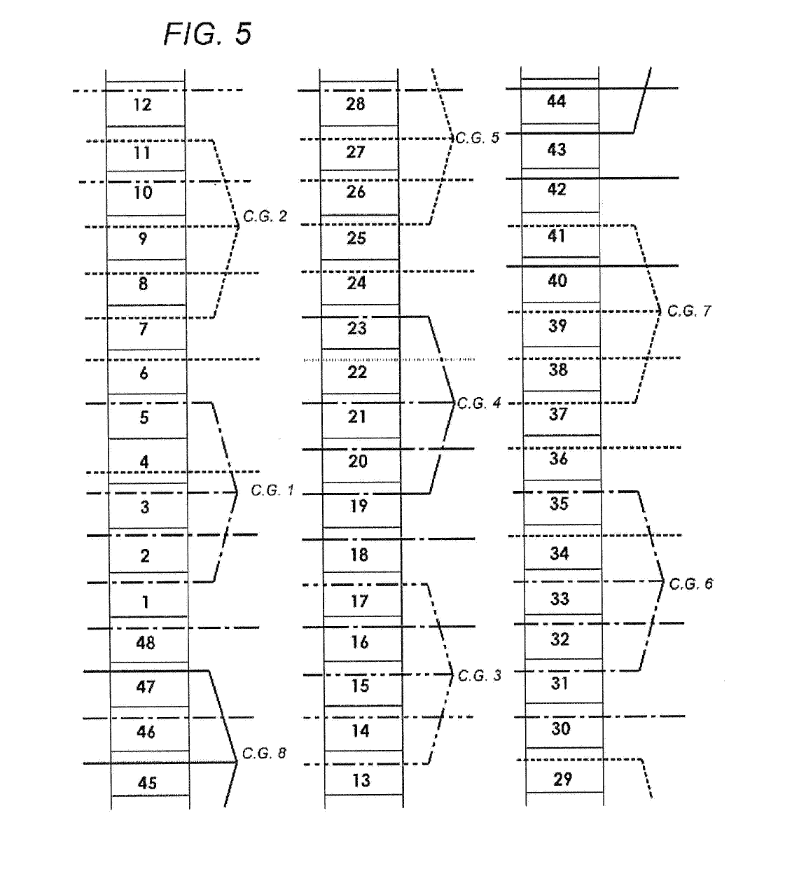

Referring to FIG. 5, in an exemplary embodiment, eight coil groups thus described are positioned circumferentially about a 48 slot stator. The coil groups are depicted as C.G. 1 through C.G. 8. Similarly, six coil groups would be distributed about a 36 slot stator. In this manner, cases are described for machines having any number of poles. In the case of a sixteen pole, 48 slot machine, instances of one, two, four, eight or sixteen coil groups are possible. Each said phase is comprised of several filars, each said filar having its own output connection, and said filars are able to be connected in parallel, resulting in the machine having much greater current carrying capability than prior art. Another result of each phase being comprised of the several filars is that the design of the machine may be of much finer granularity, e.g. partial turns, not possible with prior art. The exemplary embodiments thus allow for much greater flexibility in design, so that for example, the output of the machine may be tailored to a required RPM range. In addition, the resulting percentage of slot fill by the various coils may be maximized, resulting in greater efficiency of the machine.

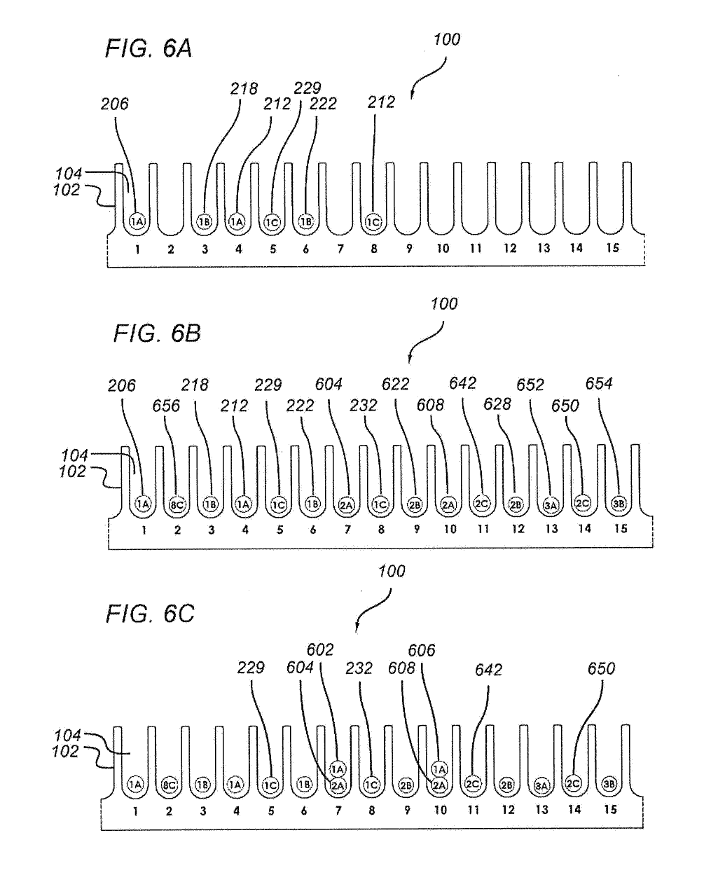

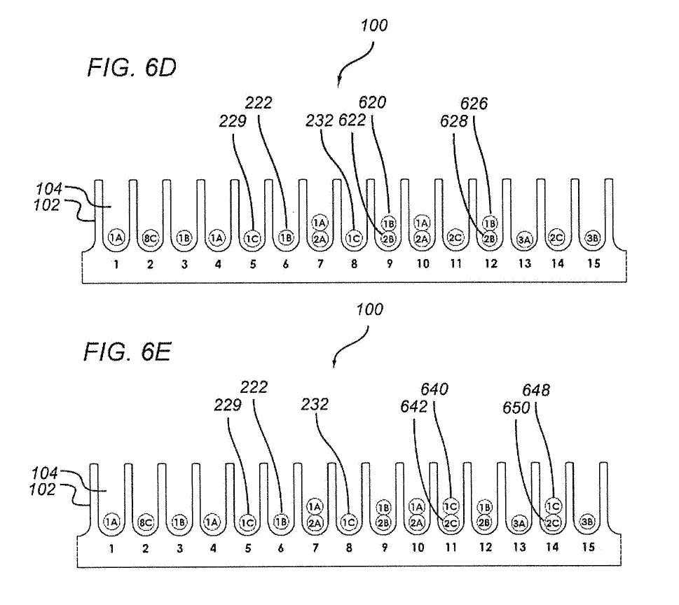

Referring to FIG. 6A, an end view of the stator illustrates the disposition of the filars of the several coil groups. As stated above, in one exemplary embodiment, in the case of a 48 slot rotor, eight coil groups would be used. The starting disposition of the coil groups results in each filar occupying two slots. This is represented by the first filar of FIG. 2A as slot segment 206 deposed into slot 1, connecting by means of end turn 208 (not shown) to slot segment 212 deposed into slot 4. The first filar of the second phase is depicted in FIG. 2B as slot segment 218 deposed into slot 3, and connected by means of end turn 220 (not shown) to slot segment 222 deposed in slot 6. The first filar of the third phase is depicted in FIG. 2C as slot segment 229 deposed into slot 5. This slot segment is connected by means of end turn 230 (not shown) to slot segment 232 deposed into slot 8.

Referring to FIG. 6B, in like manner, in an exemplary embodiment, the remaining seven coil groups are deposed into the stator, the end result being that each filar then occupies two slots of the stator, each slot of the stator thus being occupied. Therefore, the first slot segment 604 of the next filar of the first phase is deposed into slot 7 and connects to the second slot segment 608 deposed into slot 10. The first slot segment 622 of the next filar of the second phase is deposed into slot 9 and connects to the second slot segment 628 deposed into slot 12. The first slot segment 642 of the next filar of the third phase is deposed into slot 11 and connects to the next slot segment 650 deposed into slot 14. The first slot segment 652 of the third filar of phase one is shown deposed into slot 13. The first slot segment 654 of the third filar of phase two is shown deposed into slot 15. Upon completion of the deposition of all filars into the slots, the final slot segment 656 being the second slot segment of the eighth filar of phase three is deposed into slot 2.

Referring to FIG. 6C, the first filar of the first coil group then continues by means of another end turn (not shown) to be woven back into the stator at slot 7, the resulting slot segment 602 being deposed on top of the first slot segment 604 of the next filar of the same phase. This filar continues by means of end turn (not shown) connecting to slot segment 606, which is deposed on top of slot segment 608 and exiting the stator at slot 10.

Referring to FIG. 6D, the first filar of the second phase continues by means of end turn (not shown) connecting slot segment 222 in slot 6 to slot segment 620 deposed on top of the first slot segment 622 of the second filar of that phase in slot 9. This first filar then continues by means of an end turn (not shown) to connect to slot segment 626 deposed on top of slot segment 628 in slot 12.

Referring to FIG. 6E, the first slot segment 229 in slot 5 of the first filar of the third phase connects to the second slot segment 232 in slot 8 by means of an end turn (not shown). This second slot segment 232 of the first filar of the third phase is connected by means of an end turn (not shown) to slot segment 640 deposed on top of the first slot segment 642 of the second filar of the third phase in slot 11. Slot segment 640 is connected by means of an end turn (not shown) to slot segment 648 deposed on top of the second slot segment 650 of the second filar of this third phase and exiting the stator in slot 14.

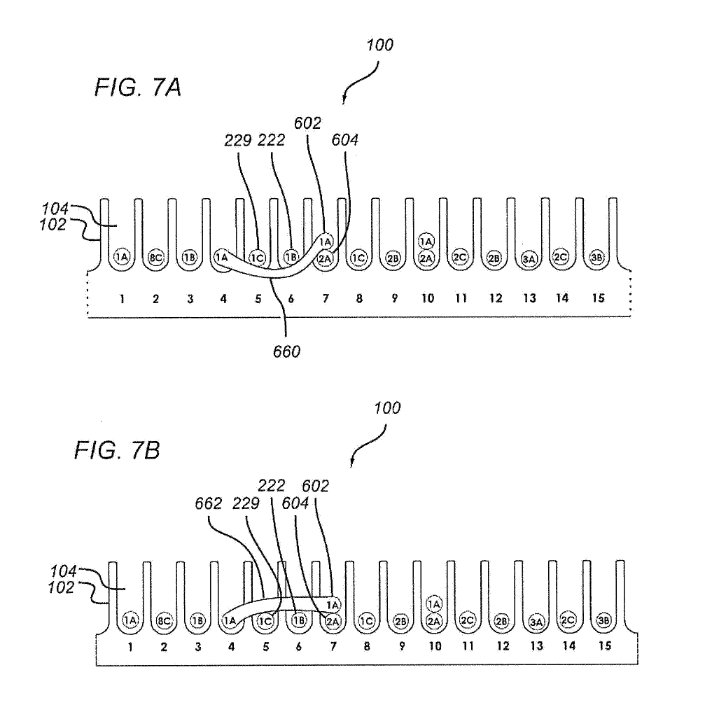

The winding may then continue in one of several manners. Referring to FIG. 7A, in one representative winding manner, the first filar of the first coil group (also being the first filar of the first phase) is shown being formed into an end turn 660 and passed under the first filar 222 of the next phase, to be then deposed on top of the first filar 604 of the second coil group. Referring now to FIG. 7B, in another representative winding manner, the first filar of the first coil group (also being the first filar of the first phase) is shown being formed into an end turn 662 and passed over the first filar 222 of the next phase, to be then deposed on top of the first filar 604 of the second coil group. To one well versed in the art, the other manners of winding will be apparent. As the winding continues in this manner, it is apparent that each slot segment of each filar is in turn deposed into the bottom of the slot, then on top of a slot segment of the next filar of the same phase, then on top of two slot segments of the same phase, this process continuing until the required number of turns for the design is reached. The formation of the coils in this manner ensures that each coil of each of the phases is deposed in a radially equal manner, thereby ensuring that each coil receives equal amounts of magnetic flux. The result of this physical arrangement is that there is no imbalance between the filars comprising the coils and no resulting circulating currents generated within the coils of a phase.

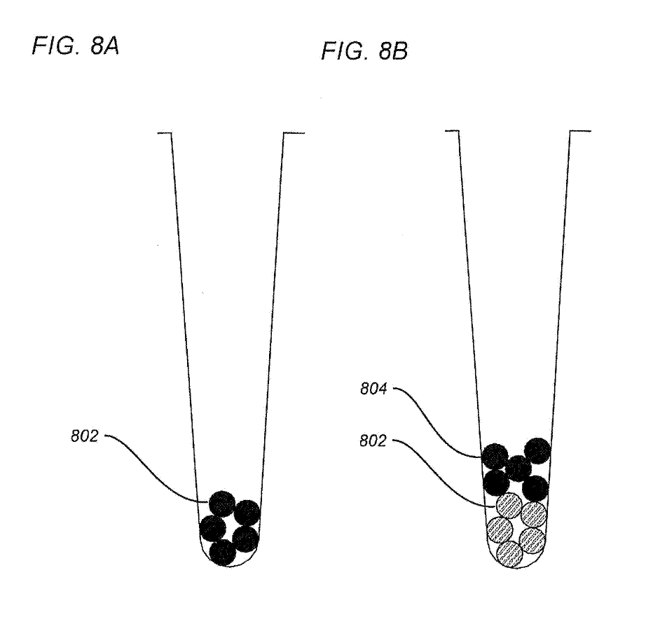

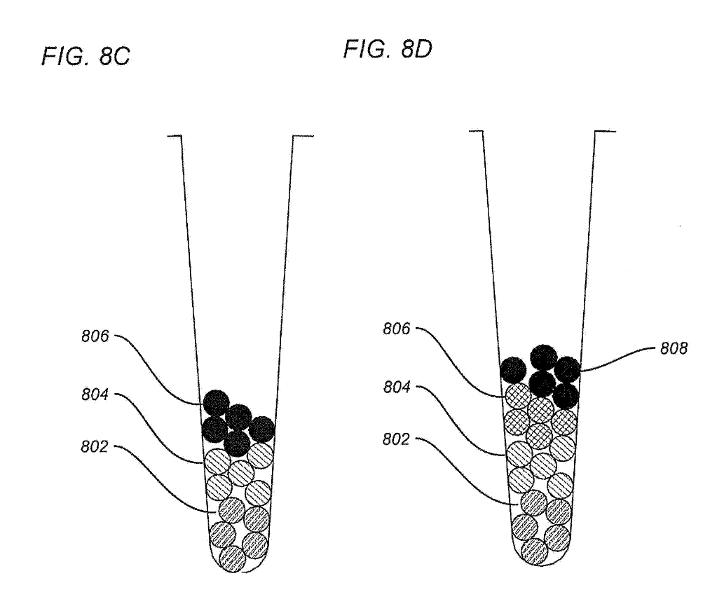

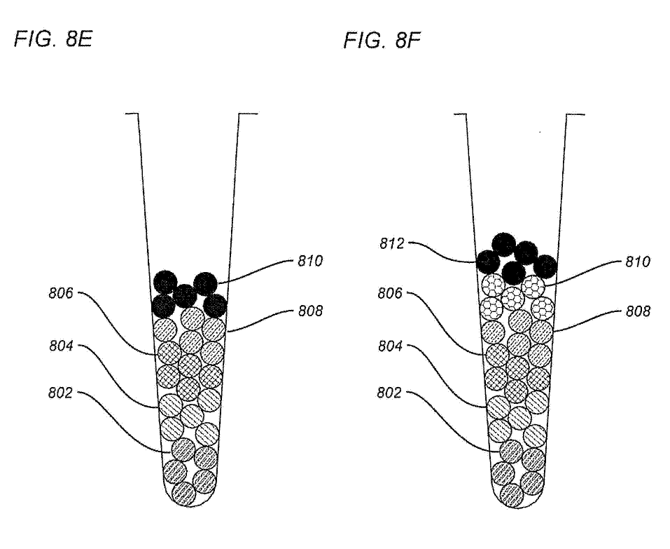

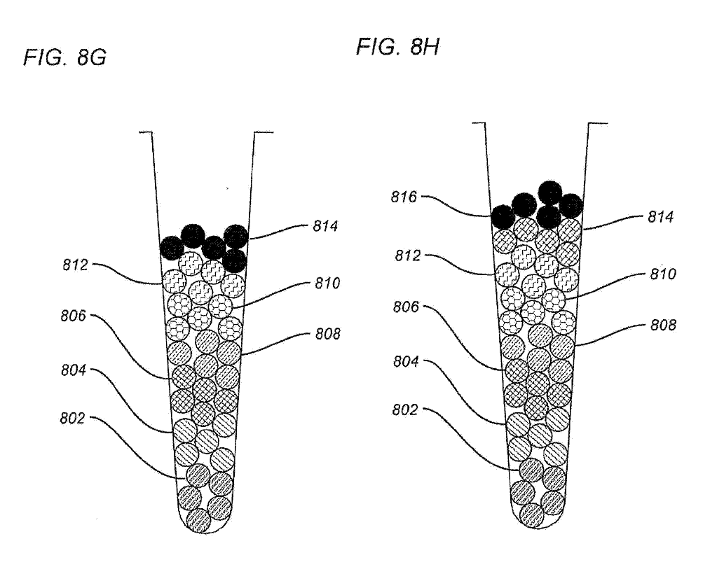

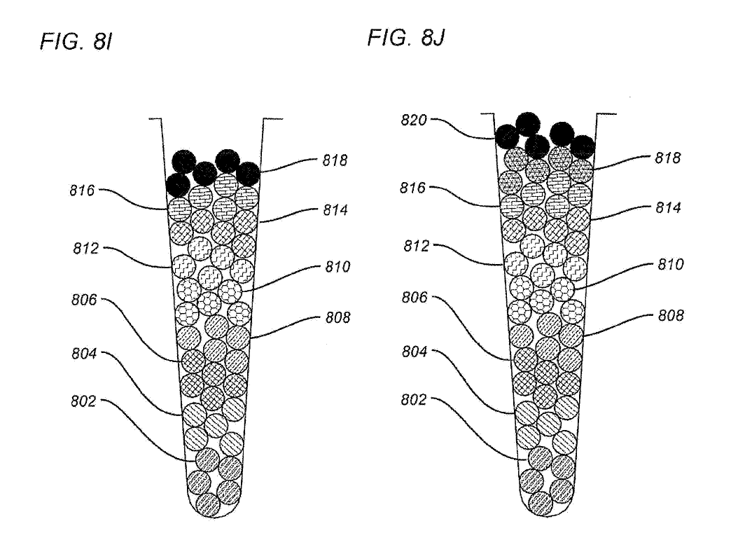

The disposition of the filars of said phases in the slots of the stator are best seen in FIGS. 8A through 8J. Referring now to FIG. 8A, a representative segment of a stator slot is shown. The slots are generally triangular in shape and are smaller in width at the bottom of the slot than at the top. The ability, in the exemplary embodiment, of the several wires comprising a filar to fill a portion of a slot, make an end-turn to travel to the next slot in the winding sequence, and to then fill a portion of that slot, and so on around the stator, takes advantage of the capability of the conductors comprising a multi-conductor filar to alter their inter-relational geometry. Thus, the geometry of such a filar bundle can be altered during the winding process as appropriate to optimize both the arrangement of end turns and slot fill.

Referring now to FIG. 8A, the arrangement of, in this case, the five conducting wires that comprise a filar 802 are shown in the bottom of the slot. The inherent geometry of the slot forces the geometry of the first filar in the bottom of the slot to be generally cylindrical in shape. As the filar leaves the slot and makes an end turn on its way to taking its assigned place in the next slot in the winding sequence, instead of allowing the filar to maintain the generally cylindrical shape, it is advantageous to form the end turn of the filar into a generally planar shape and to thereby minimize the vertical area required by the end turn. This geometry allows maximization of slot fill while ensuring enough room for the end turns. An additional benefit of the planar shape of the end turns is increased surface area, which enhances cooling of the winding. Thus, the conductors of the filar, upon exiting the slot, are formed such that they assume a generally planar shape. Thus, in the bottom of the slot, the filar (constrained in shape by the narrow width of the slot) assumes a generally cylindrical shape, thereby obtaining maximum available percentage of slot fill at this portion of the slot by the filar. As the filar leaves the bottom of the slot and makes the end turn that allows it to travel to the next slot in the winding sequence, the filar (no longer constrained in shape by the width of the slot) is formed into a more flattened or planar shape, i.e., the individual strands of the filar, being positioned generally side-by-side, form a plane.

Generally speaking, the wedge shape of the slot in the exemplary embodiment determines the nature of the conductor geometry within any given filar. As subsequent filars are wound into any given slot, their location in the slot rises; thus, due to the wedge shape of the slot, the room made available for each conductor of a given filar increases, thereby allowing the conductors within filars to spread out and assume shapes that allow the maximum percentage of slot fill as the filars increase radially in distribution. Thus, the multi-conductor nature of the filar allows filar conductor geometry to change to accomplish maximum percentage of slot fill. When a given filar, located at or near the bottom of a slot, leaves the slot and makes an end turn on its way to the next slot in the winding sequence, because the filar is generally cylindrical in shape, a greater degree of forming is required to make said end turn acquire a generally planar shape than is the case when, a given filar, located at or near the top of a slot, leaves the slot and makes an end turn on its way to the next slot in the winding sequence, because the filar located at or near the top of a slot is less generally cylindrical and more generally planar in shape, and consequently a lesser degree of forming is required to make said end turn acquire a generally planar shape.

Referring now to FIG. 8B, the five conducting strands that form a slot segment of the next filar 804 are shown. In the case of this slot segment of the filar, (not as constrained in shape as in the bottom of the slot) the filar assumes a shape that is generally more planar than the shape assumed by the slot segment 802 in the bottom of the slot. This generally more planar shape permits the optimal fill of this portion of the slot by the filar. As the filar leaves the slot and makes the end turn that allows it to travel to the next slot in the winding sequence, the filar is formed into a generally planar shape, i.e., the individual strands of the filar, being positioned generally side-by-side, form a plane. As the filar enters the middle of the next slot in the winding sequence, the filar once again assumes a shape that is generally more planar than in the bottom of the slot, which again permits the optimal slot fill percentage at this portion of the slot by the filar.

Referring now in order to FIGS. 8C through 8J, the general arrangements of the sets of five strands that respectively form the next eight filars, 806 through 820, are shown. As each sequential filar is wound into the slot, the width available to the filar becomes greater because the filar's position in the slot is higher, and the width of the slot is wider. As each filar leaves the slot and makes the end turn that allows it to travel to the next slot in the winding sequence, the filar is formed into a generally planar shape, i.e., the individual strands of the filar, being positioned generally side-by-side, form a plane. As the filar enters the next slot in the winding sequence, the filar once again assumes a shape, increasingly more planar, which continues to permit the optimal fill of each successive portion of the slot by the filar.

Referring now to FIG. 8I, it can be seen that as filars assume progressively higher positions in the slot, the planar arrangement of the filars in the slot become even more pronounced, and that the fill of the slot continues to be optimal. Referring now to FIG. 8J, the difference between the arrangement of the five conductors of the first filar (in the bottom of the slot) and the five conductors of the last filar (at the top of the slot) is very apparent.

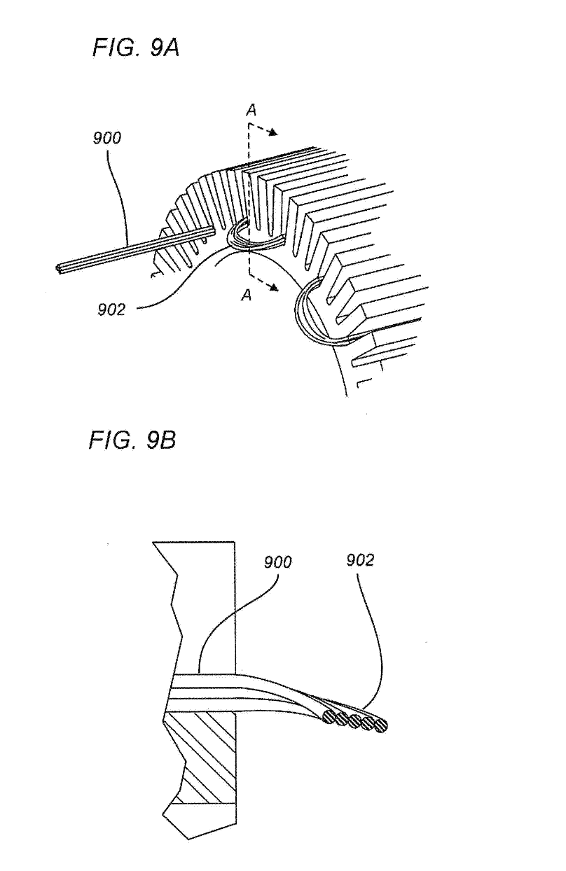

Referring now to FIG. 9A, the planar nature of the end turns is illustrated. It may be seen that as the filar 900 exits the lamination stack, it is formed into a more planar shape in the end turn 902. FIG. 9B illustrates in greater detail the transition from the constrained bundle in the slot to the planar shape of the end turn.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A coil winding, comprising:
at least one phase having a plurality of filars having at least one conductor, the filar is deposed into at least one lamination stack slot configured in a circumferential manner about a stack.

2. The coil winding of claim 1, wherein the filar of at least one phase is deposed radially outward of the next filar of the same phase circumferentially about the lamination stack, thereby ensuring that each filar at least one of receives and generates the same amount of magnetic flux preventing any electrical imbalances from being created in the machine.

3. The coil winding of claim 1, wherein the filar includes several conductors thus allowing the filar to assume the shape of the slot, resulting in optimal slot fill.

4. The coil winding of claim 1, wherein the at least one filar further comprising a particular phase being deposed into at least one lamination slot corresponding to said phase in a woven manner.

5. The coil winding of claim 2, wherein the end-turns of each filar are configured to form a lattice deposed at least one of radially inward toward the axis of the machine, and outward from the axis, as predetermined by the design of the machine.

6. The coil winding of claim 1, wherein each end turn is configured into a planar shape.

7. The coil winding of claim 6, wherein the planar shape of the end turns optimizes the use of available end turn space.

8. The coil winding of claim 6, wherein the planar shape of the end turn further comprises having the physical property of greater surface area allowing for optimal cooling of a resulting coil.

9. The coil winding of claim 1, wherein each filar terminates at a machine housing, either singly or in groups, as the current capability of said machine dictates.

10. The coil winding of claim 6, wherein the number and disposition of, each filar is predetermined by the power requirements of said machine.

11. A coil winding method, comprising:
providing an electrical machine having several phases; and
deposing circumferentially about a stack at least one filar having at least one continuous conductor into a lamination stack slot in the electrical machine.

12. The coil winding method of claim 11, further comprising: ensuring that each filar at least one of receives or generates the same amount of magnetic flux; and preventing any electrical imbalances from being created in the machine, wherein each filar of a particular phase is deposed radially outward of the next filar of the same phase circumferentially about the lamination stack.

13. The coil winding method of claim 11, further comprising:
allowing the filar to assume the shape of the slot, resulting in optimal slot fill, wherein each filar includes several conductors.

14. The coil winding method of claim 11, further comprising:
deposing at least one filar in a particular phase into the lamination slots corresponding to said phase in a woven manner.

15. The coil winding method of claim 11, further comprising:
providing end-turns of each filar; and forming a lattice deposed radially inward toward the axis of the machine, or conversely, outward from the axis as, the design of the machine dictates.

16. The coil winding method of claim 11, further comprising:
forming at least one end turn into a planar shape.

17. The coil winding method of claim 11, further comprising:
optimizing the use of available end turn space using a planar shape on the end turns.

18. The coil winding method of claim 11, further comprising:
providing an end turn having a planar shape and greater surface area to allow for optimal cooling of the resulting coil.

19. The coil winding method of claim 11, further comprising:
terminating each filar at a machine housing, either singularly or in groups, as the current capability of said machine dictates.

20. The coil winding method of claim 11, further comprising: providing a predetermined number of and disposition of at least one filar as determined by the power requirements of said machine.
